(19) United States
(12) Patent Application Publication
(10) Pub. No.: US 2014/0308174 A1
(43) Pub. Date: Oct. 16, 2014

(54) CATALYTIC COMBUSTOR IN GAS TURBINE ENGINE

(71) Applicant: KAWASAKI JUKOGYO KABUSHIKI KAISHA, Kobe-shi (JP)

(72) Inventors: Yasushi DOURA, Kobe-shi (JP); Masahiro OGATA, Kobe-shi (JP)

(73) Assignee: KAWASAKI JUKOGYO KABUSHIKI KAISHA, Kobe-shi (JP)

(21) Appl. No.: 14/316,230

(22) Filed: Jun. 26, 2014

Related U.S. Application Data
(63) Continuation of application No. PCT/JP2012/081995, filed on Dec. 11, 2012.

(30) Foreign Application Priority Data
Dec. 27, 2011 (JP) 2011-285244

(51) Int. Cl. B01D 53/94

(52) U.S. Cl. CPC B01D 53/94
USPC 422/170

(57) ABSTRACT

A catalytic combustor (2) for use in a gas turbine engine (GT) includes catalyst units (U1, U2, U3) in a multistage. The catalyst unit (U1, U2, U3) in each stage includes a support material (64) for supporting the respective catalyst unit (U1, U2, U3) against the pressure of a gas. The catalyst unit (U1, U2, U3) in each stage is unitized together with the support material (64) and the catalyst units (U1, U2, U3) are removably fitted to a combustor housing (50).

### CROSS REFERENCE TO THE RELATED APPLICATION

This application is a continuation application, under 35 U.S.C §111(a) of international application No. PCT/JP2012/081995, filed Dec. 11, 2012, which claims priority to Japanese patent application No. 2011-285244, filed Dec. 27, 2011, the entire disclosure of which is herein incorporated by reference as a part of this application.

### BACKGROUND OF THE INVENTION

1. Field of the Invention

The present invention relates to a catalytic combustor used in a gas turbine engine having a plurality of removable catalytic units built therein.

2. Description of Related Art

The catalytic combustor mounted on the gas turbine engine has advantages in that, inter alia, no NOx is substantially emitted and methane of a concentration so low as to be unable to combust can be oxidized and is one of numerous technologies that can be addressed to the environment related issue such as low pollution and global warming. In this respect, see, for example, the patent document 1 listed below.

Prior Art Literature

Patent Document 1: JP Laid-open Patent Publication No. 2011-196355

Also, as a combustion catalyst used under a high pressure condition, for example, 05 MPa or higher pressure condition such as in a gas turbine engine, such a multistage type shown in FIG. 5 is often used by the following reasons. In the first place, since ignitability is poor under the high pressure condition, a plurality of kinds of catalyst for ignition purpose and combustion purpose are required. In the second plate, while in order to terminate the reaction completely a catalyst carrier having a certain length is required, the manufacture of such a long catalyst carrier is so difficult to accomplish, and therefore, it is desirable to divide into multiple stages. Even when the multistage design is employed, under the high pressure condition, the force acting on the catalyst carrier 102 is high due to the differential pressure and, therefore, a support member 104 for supporting the catalyst carrier 102 is required for each stage. As discussed above, the combustion catalyst under the high pressure is of a multistage design and comes to have such a structure in which the support member 104 is employed for each stage of the catalyst carrier 102 and the catalyst carriers 102 and the support members 104 are fitted inside a housing 106.

In the catalytic combustor of the structure discussed above, when it comes to the replacement of the catalyst carrier 102 in each stage other than the uppermost stage during a maintenance servicing, the catalyst carrier 102 to be replaced and the catalyst carrier 102 in the upper stage must be cut apart and then removed from each other. Therefore, the workability is low, and also it is indeed wasteful because the catalyst carrier 102 in the upper stage, which need not be replaced, is broken down.

### SUMMARY OF THE INVENTION

In view of the foregoing, the present invention has been devised to substantially eliminate the problems and inconveniences inherent in the prior art catalytic combustor structure and is intended to provide a catalytic combustor having an improved workability in replacement of the catalyst and assemblage.

In order to accomplish the foregoing object, the present invention provides a catalytic combustor for use in a gas turbine engine, which includes a plurality of catalyst units in a multistage and a hollow tubular main body for accommodating the catalyst unit therein. The catalyst unit in each stage has a catalyst carrier and a support material for supporting the catalyst carrier and is removably fitted to a housing forming a contour of the main body. It is to be noted that the term “multistage” referred to hereinabove and hereinafter is to be understood as meaning that a plurality of catalytic units are disposed in a row conforming to the direction of flow of gas.

According to the present invention, since the catalyst unit in the multistage is removably fitted to the catalytic combustor, when one of the catalyst units is to be replaced during a maintenance servicing, the remaining catalyst units need not be replaced. As a result, the workability in replacing and assembling the catalyst carrier can be increased.

In a preferred embodiment of the present invention, the catalytic combustor also preferably includes a casing disposed within the main body and removably supported by the housing, in which case each of the catalyst units is incorporated replaceably within the casing. According to this structural feature, after the casing has been removed from the housing to the outside of the combustor, the catalyst units can be removed from the casing one at a time. Thus, since a replacement work of the catalyst unit can be carried out outside of the housing, the workability increases further.

Where the casing is employed, the housing and the casing are preferably of a cylindrical shape and the catalyst are similarly of a columnar shape.

Where the casing is employed, the catalytic combustor may include a covering body removably connected with one axial end portion of the main body, in which case the casing is removable from the axial end portion of the main body to the outside of the main body. According to this structural feature, since the casing having the catalyst unit incorporated therein can be axially selectively removed and inserted from one end portion of the housing, the replacement workability of the catalyst unit increases.

There the casing is employed, the main body may have an axial direction extending vertically, while its inner peripheral surface of the main body is provided with a support projection, and may also include a covering body connected removably. In this case, the casing has a first collar, which is provided in an upper end portion of the casing and protrudes radially outwards, and a second collar which is provided in a lower end portion of the casing and protrudes radially inwards. The first collar is supported and placed on the support projection, the catalyst units are stacked vertically, and a unit case for the lowermost catalyst unit rests on the second collar. According to this structural feature, with a simplified structure, the catalyst units can be incorporated into the catalytic combustor.

In a preferred embodiment of the present invention, each of the catalyst units preferably includes a unit case, the catalyst carrier is accommodated within the unit case, and the support material is disposed within the unit case on a downstream side of the catalyst carrier. According to this structural feature, since unitization is achieved with the catalyst carrier and the support material accommodated within the unit case, each of the catalyst units is such that the catalyst carrier is stably supported by the support material.

Any combination of at least two constructions, disclosed in the appended claims and/or the specification and/or the accompanying drawings should be construed as included within the scope of the present invention. In particular, any combination of two or more of the appended claims should be equally construed as included within the scope of the present invention.

### BRIEF DESCRIPTION OF THE DRAWINGS

In any event, the present invention will become more clearly understood from the following description of preferred embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 is a schematic structural diagram showing a gas turbine engine equipped with a catalytic combustor designed in accordance with a preferred embodiment of the present invention;

FIG. 2 is a perspective view showing the gas turbine engine;

FIG. 3 is a schematic longitudinal sectional view showing the catalytic combustor;

FIG. 4 is a schematic structural diagram showing one of catalyst units forming respective parts of the catalytic combustor; and

FIG. 5 is a schematic longitudinal sectional view showing the conventional multistage catalytic combustor.

### DESCRIPTION OF PREFERRED EMBODIMENTS

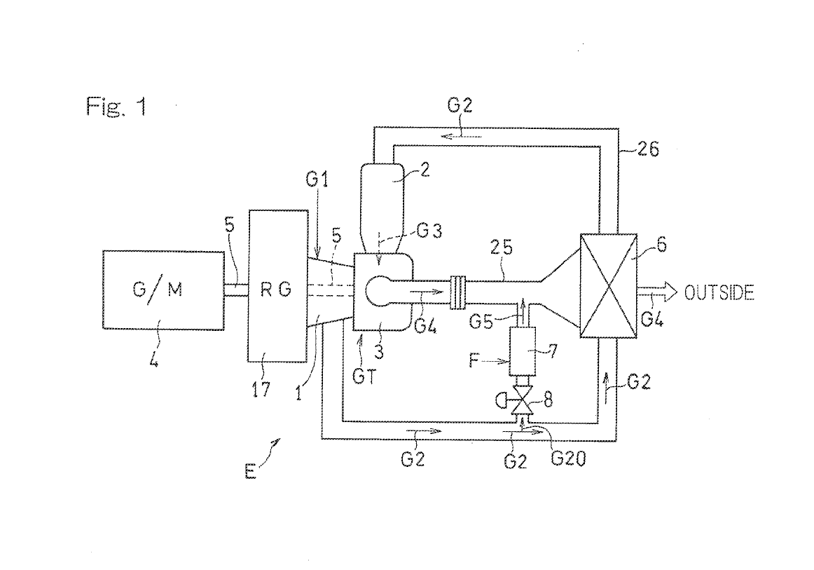

Hereinafter a preferred embodiment of the present invention will be described in detail with reference to the accompanying drawings. A gas turbine engine GT employing the catalytic combustor designed in accordance with the preferred embodiment of the present invention is shown in FIG. 1. The gas turbine engine GT shown therein includes a compressor 1, a catalytic combustor 2 utilizing a catalyst such as, for example, platinum and/or palladium, and a turbine 3. By an output of this gas turbine engine GT, a rotating machine 4, which concurrently serves as an electric power generator and a starter, is driven. The gas turbine engine G and the rotating machine 4 cooperate with each other to define an electric power generating device E.

The gas turbine engine GT is a lean fuel intake gas turbine engine. The lean fuel intake gas turbine engine utilizes as a fuel an inflammable component contained in a working gas of a concentration lower than the inflammability limit concentration. Such a working gas is prepared by mixing a low calorie gas such as, for example, coal mine methane (CMM) emitted in a coal mine, with an air or a ventilation air methane (VAM) or the like, discharged from a coal mine, and the concentration of inflammable component is so adjusted as to be incapable of being burned during compression by the compressor. Then, the working gas is sucked into the engine.

Such a working gas G1 as a mixture of the ventilation air methane (VAM) and the coal mine methane (CMM) is compressed by the compressor 1 to generate a compressed gas G2, and the high pressure compressed gas G2 is supplied to the catalytic combustor 2. This compressed gas G2 is burned as a result of reaction with the catalyst such as, for example, platinum and/or palladium in the catalytic combustor 2 to generate a high temperature, high pressure combustion gas G3, and the combustion gas G3 is supplied to the turbine 3 to drive the latter. The turbine 3 is drivingly connected with the compressor 1 through a rotary shaft 5 and, therefore, the compressor 1 is driven by the turbine 3. The rotary shaft 5 and the rotating machine 4 are drivingly connected with each other through a reduction gear 17. The rotating machine 4 is driven by the rotation of the turbine 3 and, thus, an electric power is obtained. In this way, a electric power generating device E including the gas turbine engine GT and the rotating machine 4 is formed.

The gas turbine engine GT also includes a regenerator (heat exchanger) 6 for heating the compressed gas G2, which is introduced into the catalytic combustor 2 from the compressor 1, by an exhaust gas G4 from the turbine 3, and a warming burner 7 for activating the catalyst by increasing the temperature of the compressed gas G2, which flows into the catalytic combustor 2, by increasing the temperature of the exhaust gas G4 at the time of start. This warming burner 7 mixes a fuel F into an extracted gas G20 partially extracted from the compressed gas G2 which has been compressed by the compressor 1 so as to flow towards the regenerator 6 to flame burn so mixed gas. The resultant warming gas G5 from the warming burner 7 is mixed into the exhaust gas G4, supplied from the turbine 3 to the regenerator 6, thereby to warm the exhaust gas G4. The warming burner 7 is connected with a bleed valve 8 for controlling the amount of supply of the extracted gas G20 towards the warming burner 7.

The regenerator 6 and the catalytic combustor 2 are fluid connected with each other through a downstream side compressed gas passage 26 and, accordingly, the compressed gas G2 is supplied from the regenerator 6 towards the catalytic combustor 2. The turbine 3 and the regenerator 6 are fluid connected with each other through a hollow tubular exhaust duct 25. The exhaust gas G4 flowing from the regenerator 6 is discharged to the outside after having flown through a silencer (not shown).

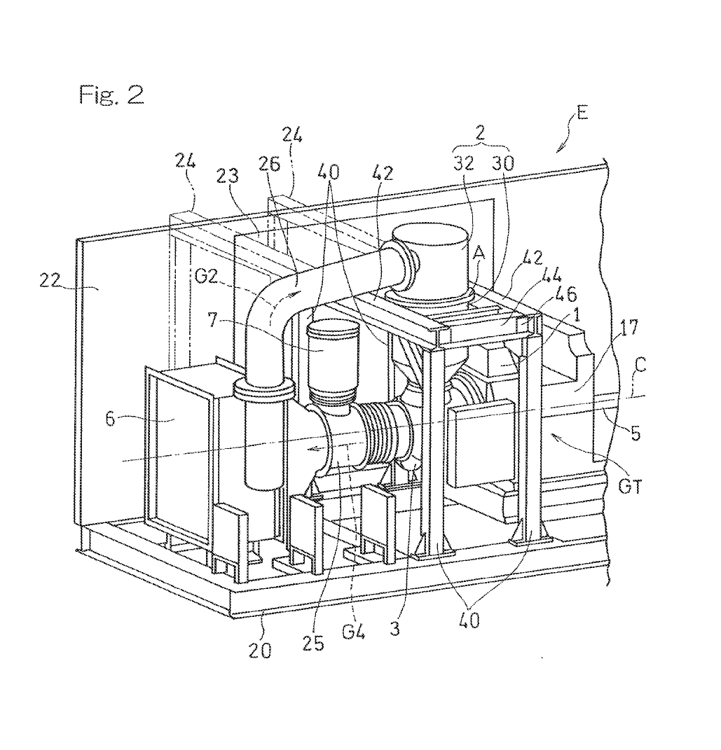

FIG. 2 illustrates a perspective view showing an important portion of the electric power generating device E. As shown therein, the gas turbine engine GT is accommodated within a package 22 in a fashion supported on a base bench 20, the regenerator 6 is fluid connected with one axial end of the turbine 3 with respect to an axial direction C, i.e., a left side as viewed in FIG. 2, through the exhaust duct 25, and the warming burner 7 is fluid connected with an upper portion of the exhaust duct 25. The opposite axial end of the turbine 3 with respect to the axial direction C, i.e., a right side as viewed in FIG. 2, is fluid connected with the compressor 1 and the reduction gear 17 is connected with the opposite end of the compressor 1 remote from the turbine 3. The opposite end of the reduction gear 17 remote from the compressor 1 is connected with the electric power generator 4 (best shown in FIG. 1) through the rotary shaft 5.

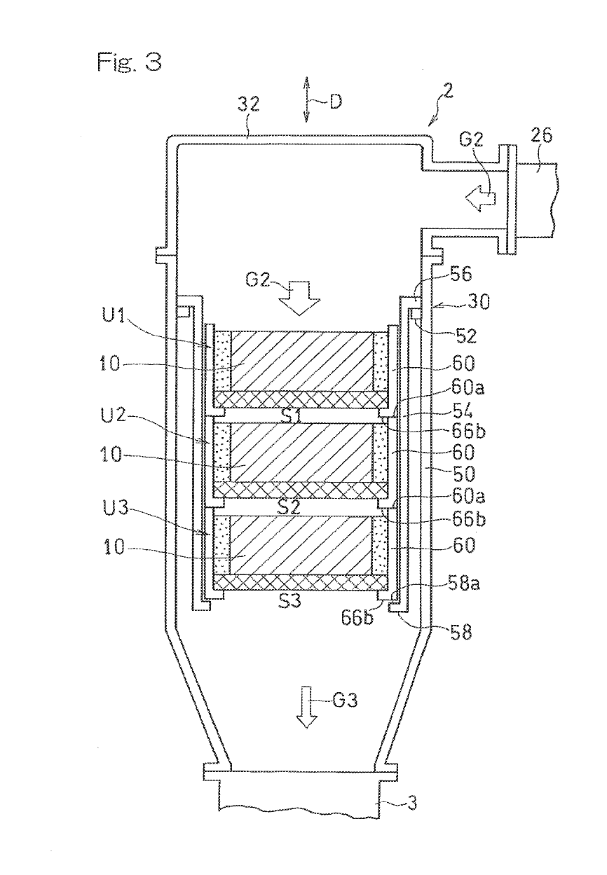

The catalytic combustor 2 is connected with a top portion of the turbine 3. The catalytic combustor 2 and the regenerator 6 are fluid connected with each other through the downstream side compressed gas passage 26 through which the compressed gas G2 is supplied from the regenerator 6 towards the catalytic combustor 2. The catalytic combustor 2 includes a hollow tubular main body 30, in which catalyst units U1, U2 and U3 are accommodated (as best shown in FIG. 3), and a cylindrical covering body 32 having one end closed and connected with an upper portion of the main body 30 through bolts.

Also, four support posts 40, two on each side of the catalytic combustor 2 with respect to the axial direction C and spaced apart from each other in the axial direction C, are fixedly mounted on the base bench 20. The two support posts 40 on each side of the catalytic combustor 2 are connected with the two support posts 40 on the opposite side of the catalytic combustor 2 by means of respective first connecting members 42 and 42, and neighboring ends of the connecting members 42 and 42 adjacent the support posts 40 are connected with each other by means of respective second connecting members 44 and 44. The first and second connecting members 42 and 44 have respective upper surfaces held substantially in flush with a joint A between the main body 30 and covering body 32 of the catalytic combustor 2.

As shown in FIG. 3, the catalytic combustor 2 employed in the embodiment is of a multistage design including, for example, the catalyst units U1, U2 and U3 stacked one above the other in three stages. One of the catalyst units U1, U2 and U3, which is positioned upstream with respect to the direction of flow of the gas, say, the catalyst unit U1 is used for ignition purpose, and the remaining two catalyst units U2 and U3 are used for oxidization or combustion purpose. This catalytic combustor 2 is so positioned as to be oriented axially, that is, with its longitudinal axis oriented vertically and, hence, the catalytic combustor 2 is so positioned that the gas can flow therethrough it in a vertical direction.

The main body 30 of the catalytic combustor 2 includes a housing 50 that defines the contour of the main body 30, and a lower end portion of the housing 50 is fluid connected with the turbine 3 by means of bolts. The catalyst units U1, U2 and U3 are independently removably accommodated within the housing 50. In other words, an annular support projection 52 protruding inwardly of the housing 50 is welded to an inner face of an upper portion of the housing 50, and a cylindrical casing 54 is disposed within the main body 30. The casing 54 has an outer diameter so chosen as to be smaller than the inner diameter of the support projection 50.

As clearly shown in FIG. 3, the casing 54 has upper and lower ends opposite to each other, and a first collar 56 is formed in the upper end of the casing 54 so as to protrude radially outwardly and a second collar 58 is formed in the lower end of the casing 54 so as to protrude radially inwardly. The first collar 56 has an outer diameter so chosen to be greater than the inner diameter of the support projection 52 and, also, smaller than the inner diameter of the housing 50 such that the first collar 56 can rest on the support projection 52 and be connected therewith by means of bolts. Accordingly, the casing 54 is removably supported by and within the housing 50.

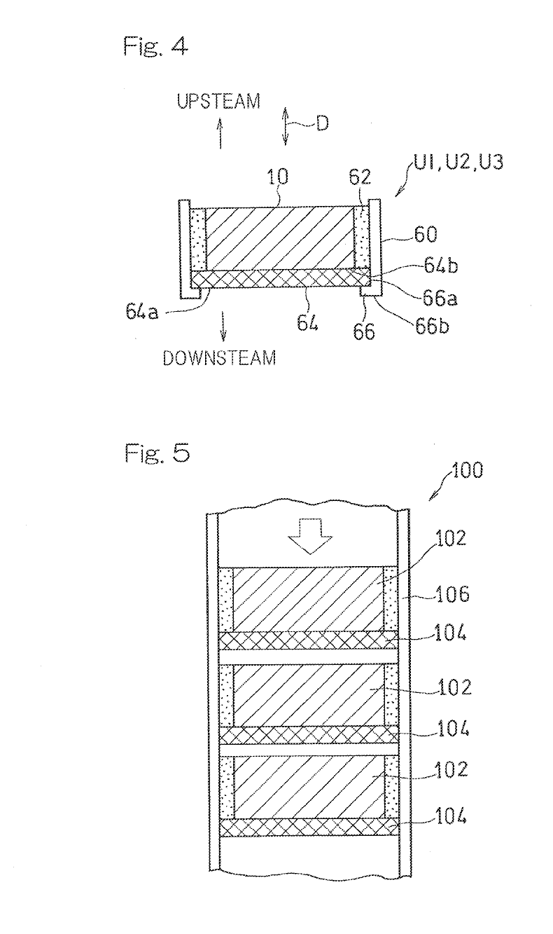

As shown in FIG. 4, each of the catalyst units U1 to U3 is of a structure in which a columnar catalyst carrier 10 is accommodated within a cylindrical unit case 60 through a sealing member 62 and, within the cylindrical unit case 60, a columnar support material 64 is accommodated on a downstream side of the catalyst carrier 10. More specifically, a collar shaped retaining piece 66 is formed with a downstream side end portion of the unit case 60 so as to protrude radially inwardly of the unit case 60, and an outer peripheral portion of the support material 64 rests on this retaining piece 66 so as to be retained by the unit case 60.

The catalyst carrier 10 is made of, for example, a stainless thin plate and is of a honeycomb structure having meshes oriented in the axial direction. The annular sealing member 62 is made of a heat insulating material and is interposed between the unit case 60 and the catalyst carrier 10 to allow the catalyst carrier 10 to be held by the unit case 60. The support material 64 is of a honeycomb structure made of a stainless material and having meshes oriented in the axial direction, the meshes of the honey comb being so chosen as to be rougher than those in the catalyst carrier 10.

As shown in FIG. 3, the unit case 60 of each of the catalyst units U1, U2 and U3 has an outer diameter somewhat smaller than the inner diameter of the casing 54, and the catalyst units U1, U2 and U3 are inserted from above into the casing 54 and are hence nested within the casing 54. One of the catalyst units U1, U2 and U3 which is held at a downstream position within the casing 54, that is, the catalyst unit U3 is retained by the casing 54 with a lower surface 66b of the retaining piece 66 of the associated unit case 60 held in contact with an upper surface 58a of the second collar 58 of the casing 54. Each of the remaining first and second catalyst units U1 and U2 is such that a lower surface 66b of the retaining piece 66 of the unit case 60 is held in contact with an upper end 60a of the unit case 60 of the respective catalyst unit U2 and U3 on the downstream side. In this way, the catalyst units U1, U2 and U3 are accommodated within the casing 54 in a fashion spacedly stacked one above the other in the vertical direction.

The operation of the gas turbine engine GT of the structure hereinabove described will be described. At the time of start, since the temperature of the catalytic combustor 2 shown in FIG. 1 is lower than the activation lower limit temperature, the exhaust gas G4 is warmed up by the ignition of the warming burner 7 to allow the regenerator 6 to be warmed. By so doing, the compressed gas G2 flowing through the regenerator 6 is boosted in temperature to cause the catalytic combustor 2 to be heated to a temperature equal to a predetermined temperature at which the catalytic reaction takes place within the catalytic combustor 2. When the rated operation starts, the temperature of the exhaust gas G4 increases, and therefore, the compressed gas G2 supplied from the compressor 1 is heated to a temperature, which is sufficient to allow the catalytic combustor 2 to operate, by the effect of a heat exchange with the exhaust gas G4 within the regenerator 6. As a result, the bleeding valve 8 is closed and the warming burner 7 is therefore halted.

At this time, as shown in FIG. 3, the compressed gas G2 supplied into the catalytic combustor 2 is burned as it flows sequentially through the first to third catalyst units U1 to U3, thus producing the high temperature combustion gas G3 which is subsequently supplied to the turbine 3.

Since the compressed gas G2 flowing through the catalyst carrier 10 is of a high pressure, a large differential pressure is generated between the upstream side (primary side) and the downstream side (secondary side) of the catalyst carrier 10 having the fine meshes. The support material 64 referred to above is used to support the catalyst against such a differential pressure and cooperates with the unit case 60, the casing 54 and the support projection 52 to avoid an undesirable deformation of the catalyst carrier 10 in the axial direction.

In the description that follows, the manner of replacing the catalytic combustor 2 will now be described. At the outset, a door 23 in a side wall of the package 22 shown in FIG. 2 is opened and a temporary unloading rail 24 is installed from outside of the package 22. Thereafter, connection between the main body 30 and the covering body 32 of the catalytic combustor 2 is released by loosening the bolts, and the covering body 32 is subsequently hoisted by a crane installed in the ceiling of the package 22 to remove the covering body 32 from the main body 30. Also, by loosening the bolts the main body 30 of the catalytic combustor 2 is separated from the turbine 3. A flange portion at an upper end of the main body 30 is placed on a delivery tool (not shown) such as, for example, rollers movably fitted to the two first connecting members 42 and 42 and, then, the main body 30 of the catalytic combustor 2 is removed from the package 22 in a lateral direction along the first connecting member 42 and the unloading rail 24.

In the outside of the package 22, bolts used to connect the first collar 56 of the main body 30 of the catalytic combustor 2 shown in FIG. 3 and the support projection 52 are loosened to remove the casing 54 in a direction upwardly of the main body 30. Thereafter, one or some of the catalyst units U1, U2 and U3, which become defective, is/are removed from the casing 54 for replacement with one or some fresh catalyst units.

After the replacement of the catalyst unit or units, following the procedures converse to those described above, the catalyst units U1, U2 and U3 are placed inside the casing 54 in the manner described hereinbefore and, thereafter, the casing 54 is inserted into the main body 30, followed by bolt connection between the first collar 56 of the casing 54 and the support projection 52.

The defective catalyst unit can be detected by measuring the difference in temperature between inlet and outlet of each of the catalyst units U1 to U3 with the use of a temperature measuring gauge such as, for example, a thermocouple.

In the construction described hereinabove, since the multistage catalyst units U1, U2 and U3 are removably fitted to the combustor 2, when one of the multistage catalyst units is to be replaced during the maintenance servicing, there is no need to replace the other catalyst units U1, U2 and U3. Therefore, the workability in replacing or assembling the catalyst carrier 10 can be increased.

Also, after the casing 54 has been removed from the housing 50 to the outside of the combustor 2, each of the catalyst units U1, U2 and U3 can be removed from the casing 54. Since in this way the replacement work of the catalyst units U1, U2 and U3 can be done in the outside of the housing 50, the workability is further increased. More specifically, since each of the catalyst units U1, U2 and U3 is assembled having been inserted sequentially from above into the casing 54, removal of the casing 54 from the housing 50 allows each of the catalyst units U1, U2 and U3 to be removed from the combustor 2 and, therefore, the workability increases further.

Since the casing 54 having the catalyst units U1, U2 and U3 assembled therein can be axially inserted into and removed from one end portion of the housing 50, the workability in replacement of the catalyst units U1, U2 and U3 increases. Also, after the covering body 32 has been removed, the casing 54 can be removed from the main body 30 in the axial direction D of the main body 30, and therefore, the structure of the combustor 2 is rendered to be simple.

Also, since the catalyst carrier 10 and the support material 64 are accommodated within the unit case 60 so as to be unitized to form each of the catalyst units U1, U2 and U3, the each is such that the catalyst carrier 10 is stably supported by the support material 64 within the unit case 60.

Although in describing the foregoing embodiment, the casing 54 is removed from the main body 30 in the axial direction D of the main body 30, the present invention is not necessarily limited thereto and it may be removed in a radial direction. In such case, the housing 50 of the main body 30 is made of a member that is split into two in a radial direction or the housing 50 has to be provided with a casing extracting door so that with the use of a forklift the casing 54 can be removed. Also, the number of the catalyst units may not necessarily limited to three stages as shown and described, two or four or more stages can be employed.

Furthermore, although in the foregoing embodiment, as an intake air a mixture of the coal mine methane and the ventilation air methane has been shown and described as employed, the present invention is not necessarily limited thereto and the present invention can be applied to the general gas turbine engine in which the air is employed as an intake air and a fuel is supplied into the catalytic combustor 2 to achieve combustion. Yet, the casing, the catalyst units and the housing may not be limited to a cylindrical shape, but may have a polygonal shape such as, for example, a square shape.

Although the present invention has been fully described in connection with the preferred embodiments thereof with reference to the accompanying drawings which are used only for the purpose of illustration, those skilled in the art will readily conceive numerous changes and modifications within the framework of obviousness upon the reading of the specification herein presented of the present invention. Accordingly, such changes and modifications are, unless they depart from the scope of the present invention as delivered from the claims annexed hereto, to be construed as included therein.

### Reference Numerals

1 . . . . Compressor

2 . . . . Main combustor (Catalytic combustor)

3 . . . . Turbine

6 . . . . Regenerator

10 . . . . Catalyst carrier

30 . . . . Main body

32 . . . . Covering body

50 . . . . Housing

52 . . . . Support projection

54 . . . . Casing

56 . . . . First collar

58 . . . . Second collar

60 . . . . Unit case

64 . . . . Support material

GT . . . . Gas turbine engine

U1, U2, U3 . . . . Catalyst unit

What is claimed is:

1. A catalytic combustor for use in a gas turbine engine, which comprises:
a plurality of catalyst units in a multistage, the catalyst unit in each stage having a catalyst carrier and a support material to support the catalyst carrier;
a hollow tubular main body to accommodate the catalyst unit therein; and
a housing forming a contour of the main body, the catalyst unit being removably fitted to the housing.

2. The catalytic combustor as claimed in claim 1, further comprising a casing disposed within the main body and removably supported by the housing,
wherein each of the catalyst units is incorporated replaceably within the casing.

3. The catalytic combustor as claimed in claim 2, wherein the housing and the casing are of a cylindrical shape and the catalyst are of a columnar shape.

4. The catalytic combustor as claimed in claim 2, further comprising a covering body removably connected with one axial end portion of the main body,
wherein the casing is removable from the axial end portion of the main body to the outside of the main body.

5. The catalytic combustor as claimed in claim 2, wherein the main body has an axial direction extending vertically and has its inner peripheral surface provided with a support projection and includes a covering body connected removably;
wherein the casing has a first collar, which is provided in an upper end portion of the casing and protrudes radially outwards, and a second collar which is provided in a lower end portion of the casing and protrudes radially inwards; and
wherein the first collar is supported and placed on the support projection, the catalyst units are stacked vertically, and a unit case for the lowermost catalyst unit rests on the second collar.

6. The catalytic combustor as claimed in claim 1, wherein
each of the catalyst units includes a unit case,
the catalyst carrier is accommodated within the unit case, and
the support material is disposed within the unit case on a downstream side of the catalyst carrier.
